(19) United States
(12) Patent Application Publication
(10) Pub. No.: US 2021/0390555 A1
(43) Pub. Date: Dec. 16, 2021

(54) METHOD AND SYSTEM FOR PERFORMING ADVANCED CONFIGURABLE GEOSPATIAL LOCATION ANALYSIS

(71) Applicant: SAUDI ARABIAN OIL COMPANY, Dhahran (SA)

(72) Inventors: Thamer Khalid Tarabzouni, Dhahran (SA); Faisal Yousef Hammad, Dammam (SA)

(73) Assignee: SAUDI ARABIAN OIL COMPANY, Dhahran (SA)

(21) Appl. No.: 16/900,031

(22) Filed: Jun. 12, 2020

(51) Int. Cl. G06Q 30/00; G06Q 50/16; G06Q 30/02; G06Q 10/10; G06Q 50/02; G06Q 50/04; G06N 20/00; G01C 21/20

(52) U.S. Cl. CPC G06Q 30/0185; G06Q 50/165; G06Q 30/0205; G01C 21/20; G06Q 50/02; G06Q 50/04; G06N 20/00; G06Q 10/10

(57) ABSTRACT

A method for performing advanced configurable geospatial location analysis may include obtaining, by a communication interface, a selection of a point of interest within a geographic information system (GIS). The point of interest may be a mapping object that corresponds to geospatial location information that defines a plurality of objects and geographical boundaries within the GIS. The method may include obtaining, by the communication interface, asset information regarding a plurality of land use objects using a plurality of data sources. The method may include identifying, by a computer processor and based on the asset information, a geographical buffer within the GIS between the point of interest and the plurality of land use objects.

### BACKGROUND

Geographical Information Systems (GISs) are currently used for geospatial location analysis to evaluate assets and points of interest in an area of interest. Assets may be overlapped, directly connected, or indirectly connected to other assets in the area of interest. As such, developing the point of interest (i.e., a specific asset) involves obtaining permits for land use to confirm that the point of interest is free of conflicts with respect to other assets in the area of interest. These permits usually require extensive time for evaluating and validating information relating to any point of interest.

### SUMMARY

In general, in one aspect, embodiments disclosed herein relate to a method for performing advanced configurable geospatial location analysis. The method includes obtaining, by a communication interface, a selection of a point of interest within a geographic information system (GIS). The point of interest is a mapping object that corresponds to geospatial location information that defines a plurality of objects and geographical boundaries within the GIS. The method includes obtaining, by the communication interface, asset information regarding a plurality of land use objects using a plurality of data sources. The method includes identifying, by a computer processor and based on the asset information, a geographical buffer within the GIS between the point of interest and the plurality of land use objects. The method includes determining, by the computer processor, whether an object conflict exists between the point of interest and the plurality of land use objects based on the geographical buffer.

In general, in one aspect, embodiments disclosed herein relate to a system for performing advanced configurable geospatial location analysis. The system includes a communication interface that obtains a selection of a point of interest within a geographic information system (GIS) and obtains asset information regarding a plurality of land use objects using a plurality of data sources. The point of interest is a mapping object that corresponds to geospatial location information that defines a plurality of objects and geographical boundaries within the GIS. The system includes a computer processor that identifies, based on the asset information, a geographical buffer within the GIS between the point of interest and the plurality of land use objects, and determines whether an object conflict exists between the point of interest and the plurality of land use objects based on the geographical buffer.

In general, in one aspect, embodiments disclosed herein relate to non-transitory computer readable medium storing instructions executable by a computer processor. The non-transitory computer readable medium includes instructions for obtaining, by a communication interface, a selection of a point of interest within a geographic information system (GIS). The point of interest is a mapping object that corresponds to geospatial location information that defines a plurality of objects and geographical boundaries within the GIS. The instructions include obtaining, by the communication interface, asset information regarding a plurality of land use objects using a plurality of data sources. The instructions include identifying, by a computer processor and based on the asset information, a geographical buffer within the GIS between the point of interest and the plurality of land use objects. The instructions include determining, by the computer processor, whether an object conflict exists between the point of interest and the plurality of land use objects based on the geographical buffer.

Other aspects of the disclosure will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a schematic diagram of a method in accordance with one or more embodiments.

FIG. 2 shows a schematic diagram of a method in accordance with one or more embodiments.

FIG. 3 shows an example in accordance with one or more embodiments.

FIG. 4 shows a schematic diagram of a method in accordance with one or more embodiments.

FIG. 5 shows an example in accordance with one or more embodiments.

FIG. 6 shows a flowchart in accordance with one or more embodiments.

FIGS. 7A and 7B show a computer system and a network system in accordance with one or more embodiments.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include a method and a system to determine conflicts between various map objects (such as power lines and pipelines) within a geographic information system (GIS) software program. The embodiments provide an evaluation engine 100 (i.e., a spatial analysis engine) that analyzes possible map object conflicts based on location information. The location information may include an identified list of assets or features that are a distance away, intersected, or inclusive within a geographical buffer boundary. The assets can be set by entering values in a form that generates a buffer relevant to a specific defined feature on the map. Further, the evaluation engine 100 may perform spatial conflict analysis based on a configurable selection of GIS data to detect, illustrate, and list all of these conflicted assets or features. The assets and feature types with their related information generated from the conflict analysis engine and meeting the requested selection criteria in the form may be displayed in a list of the output data by the spatial conflict engine. This generated list of conflicted assets and features with the point of interest feature will significantly shortening a Land Use Permit (LUP) review and validate by Review Organizations(ROs) and hence optimizes the whole LUP process time frame.

The evaluation engine 100 provides conflict checks using a polygon (buffer) generated based on selected parameters around the point of interest feature and detects those assets and geological features conflicting (e.g. intersecting, or falling a distance away) with this point of interest feature. These conflicts may be identified and highlighted in an output GIS map within a graphical user interface. These conflicts can be either field assets or LUP features (also referred to as objects) where both can be represented on the map as points, polylines, or polygons appropriately colored and classified so that similar assets and areas with the same land use types are in the same representation. Further, outlines may be set to hide mode and only the colors may remain such that a graphical representation of the point of interest remains based in colored symbols alone. Similarly, the generated conflict objects may be filtered and separated for more in-depth conflict analysis and inspections for more validations and verifications.

One or more embodiments may be directed towards an evaluation engine 100 for preparing a LUP request, submitting the LUP request, and then verifying whether the LUP request has a conflict or may be accepted. As such, the evaluation engine 100 provides conflict checks and analysis of multiple geological features with respect to a point of interest based on selected parameters, and generates a LUP based on conflict results. The evaluation engine 100 may enable an LUP system to be automated using digital submissions and extracting land use information from various servers. For example, land use map assets may include objects affected by disaster areas like fires and earthquakes, off-shore and on-shore drilling operations, planning for flood analysis, planning for city planning of logistic and infrastructure that identify areas affected by hydrocarbon releases, and highlighted areas coverage for rescue activities.

Current GISs do not include evaluation engine 100s for determining geospatial conflicts among land use objects as part of preparing and approving LUP requests. In particular, current GISs do not provide an evaluation engine 100 providing conflict checks and analysis of multiple geospatial features with respect to a point of interest based on automatically generated geographical buffers. That is, current GISs lack the ability to automatically determine any parameters of interest and to automatically incorporate conflict matching between map objects.

In some embodiments described in this disclosure, the shortcomings of current GISs are solved by providing a method and a system of the evaluation engine 100 produced to enhance, expedite, and optimize the review of LUPs in projects requesting the use of lands. Currently, the LUP review process by any assigned review organizations takes various days or weeks to be completed. This is due by the fact that it is being done manually with visual inspection of a user that analyzes whether the requested land of a LUP is intersected or the land is within a distance that follows any loss prevention safety standards. As such, the process is currently very lengthy and intensive, which usually causes review organizations to experience delays in making final review decisions. These delays end up affecting the entire LUP process time frame.

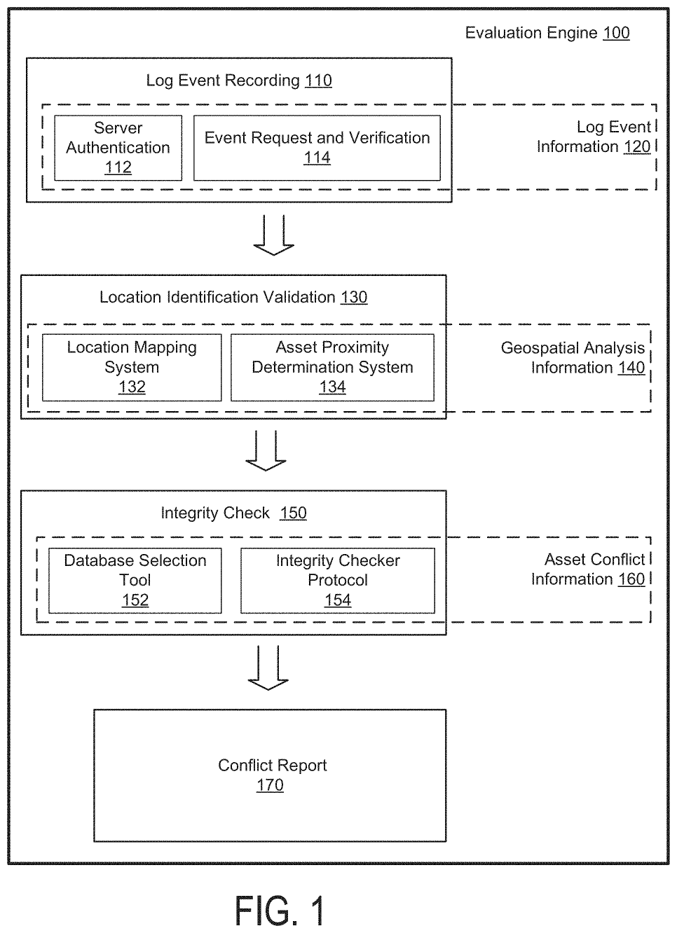

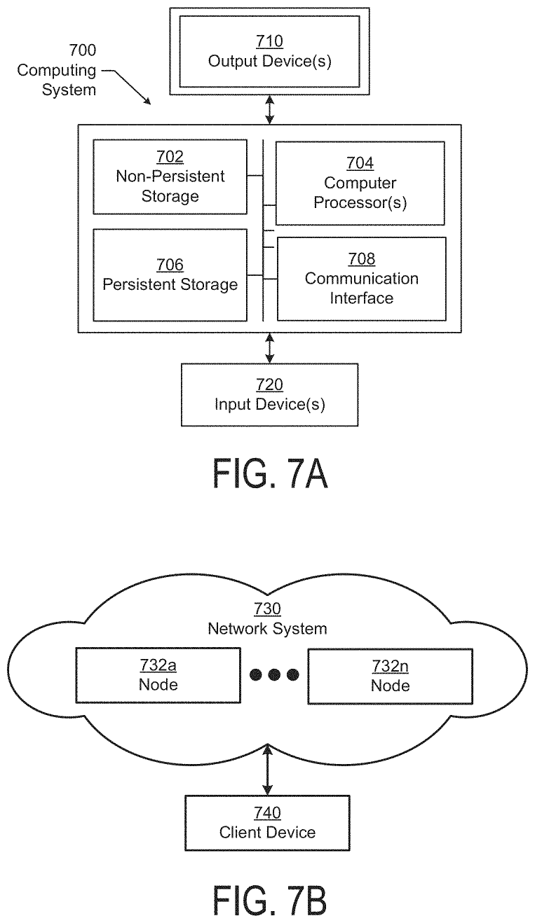

FIG. 1 shows a process for generating a conflict report 170 as part of performing advanced configurable geospatial location analysis in an evaluation engine 100. In one or more embodiments, the conflict report 170 is based on various different levels of information and processing. The conflict report 170 may include log event information 120, geospatial analysis information 140, and asset conflict information 160. The evaluation engine 100 may use any of the information included at any given time during operation in order to obtain the conflict report 170. The various information may be processed and controlled by one or more of the components described in reference to FIGS. 7A and 7B.

In some embodiments, the evaluation engine 100 may perform operations and processing as a geospatial Location Analysis Engine (LAE) by performing analysis in reference to a selected point of interest at a location on Earth. The evaluation engine 100 may analyze and determine location information in the area of interest to set a geographical buffer (i.e., an area extending along the circumference of the point of interest) around the point of interest to identify a list of assets or land use objects that are either distance away, intersected, or inclusive within this geographical buffer boundary. The evaluation engine 100 may perform advanced analysis using a decision-making server for determining all conflicts pertaining to the selected point of interest. The analysis may be based in all configured datasets of assets or land use objects available for performing the analysis against. Then, the results of the analysis may be reported back to the user in the conflict report 170 to display and illustrate the results on a GIS or a georeferenced map with the location of the point of interest on Earth. The conflict report may include identified areas where conflicts have been determined to exist. Further, similar features may be identified using similar coloring or symbols such that a user may extract and display assets and land use objects related to selected information and calculate the distance away of these assets or land use objects from the point of interest. Then, the conflict report 170 may be generated including a map and a list of the assets and land use objects to use for further analysis or as a support document for decision making. This list can be even exported and attached.

The log event information 120 may be used after a log event recording 110 is triggered. The evaluation engine 100 may create, or obtain, an instruction indicating an area of interest anywhere on Earth based on a point of interest selected by a user or a decision-making server. In this context, a user is any person responsible for directly, or indirectly, triggering the log event recording 110. Further, a decision-making server is any entity that triggers the log event recording 110 directly by sending instructions that may be configured by a person or machine learning algorithm. In log event recording 110, the area of interest may be corroborated through server authentication 112 and event request and verification 114, which may provide a direct connection between the intended application of the conflict report 170 and the area of interest. Specifically, the server authentication 112 and the event request and verification 114 may be protocols designed to validate the credentials of a user or decision-making server triggering the log event recording 110. As such, the log event information 120 may be used to identify data bases that may be relevant in creating the conflict report. At the log event information 120 may include branching connection information, geospatial location information, and conflict parameters for any area of interest. In some embodiments, the area the log event information 120 may be restricted information that may require specific credentials from the user or decision-making server to be accessed. This is to safeguard access to classified assets or LUP objects.

The geospatial analysis information 140 may be used after a location identification validation 130 is triggered. The evaluation engine 100 may obtain geospatial analysis information 140 including branching connection information, geospatial location information, and conflict parameters for any area of interest. Specifically, the evaluation engine 100 may access geospatial analysis information 140 allowed by the server authentication 112 and the event request and verification 114. The evaluation engine 100 may determine the location of assets or other land use objects in the area of interest using a location mapping system 132 and an asset proximity determination system 134. The evaluation engine 100 may use the location mapping system to analyze the branching connection information of the selected area of interest to determine the relations and interconnections between assets and land use objects in that area. Further, the evaluation engine 100 may use the asset proximity determination system to identify and categorize the types of assets in the area of interest. Assets may be any structure in an area of interest that is not a land use object. For example, assets may be pipelines, valves, or any other structure in the area of interest. Land use objects may be any portion or sub-area within the area of interest. Land use objects may be denoted as points, polylines, or polygons delimiting the boundaries of the sub-area. The objects may be used as to determine conflicts in overlapping land use objects. Each LUP object may have conflict parameters that indicate a status of the corresponding land use object (i.e., whether the land use object is being developed, specific use of the land, or an upcoming change to the current land use). As such, LUP objects may be calculated and their boundaries may be established in relation with any assets in the rest of the area of interest.

The asset conflict information 160 may be used after an integrity check 150 is triggered. The evaluation engine 100 may analyze the results of the location identification validation 130 and test the object conflict parameters for each LUP object and in relation to the point of interest. The evaluation engine 100 may use a database collection tool 152 and an integrity checker protocol 154 to test and check the information retrieved for each land use object and asset. In some embodiments, the asset conflict information 160 is limited by the access granted to the user. Specifically, one user may have different access than another such that one user may have access to various databases and a larger amount of the asset conflict information 160 when compared to another.

In some embodiments, the evaluation engine 100 outputs a conflict report 170 based on the various information processed using the log event recording 110, location identification validation 130, and the integrity checker 150. The conflict report 170 may be an output of the evaluation engine 100 being integrated as a tool in an automated Land Use Permit (LUP) solution. The evaluation engine 100 may be developed or implemented using Environmental Systems Research Institute (ESRI) ArcGIS Server platform Service Object Extension (SOE). The evaluation engine 100 may be developed or implemented using completely automated means rendering the collection of information and the generation of the report automatic over a period of time as long as the point of interest is identified.

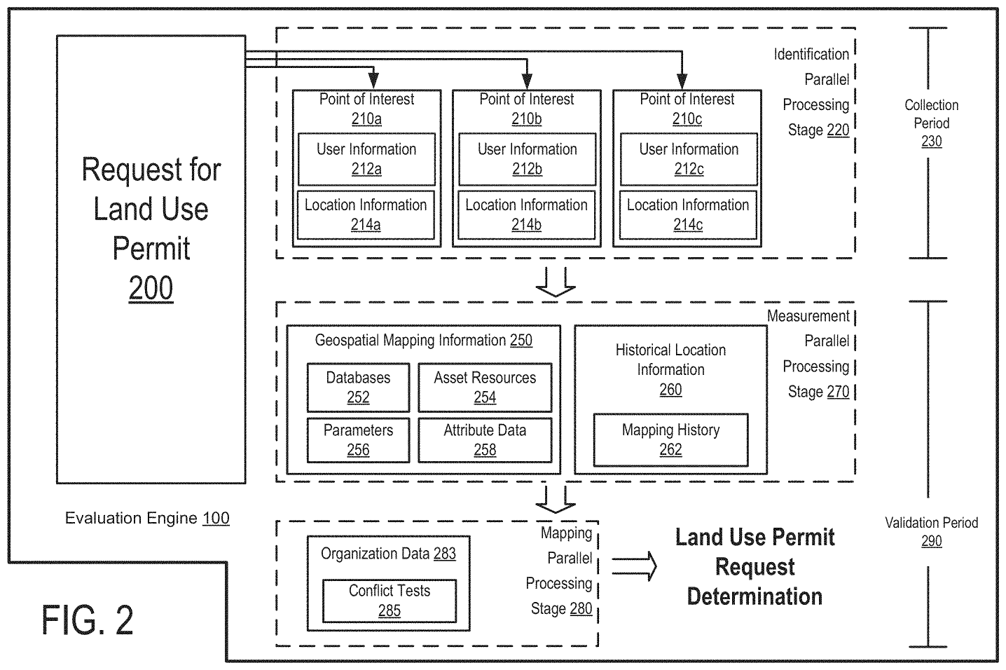

FIG. 2 shows a process for requesting an LUP and illustrates parallel processing stages required for obtaining a land use permit determination. The parallel processing stages may occur simultaneously or in order as more than one point of interest may be selected for analysis by the evaluation engine 100. In some embodiments, various LUP requests may be submitted in parallel, but only a single LUP request may be processed at any given time such that there may be a single LUP object per request. In some embodiments, the request for LUP 200 may include an identification parallel processing stage 220, a measurement parallel processing stage 270, and a mapping parallel processing stage 250 to obtain a land use permit request determination. In particular, the request may include some or all of the processes performed by the evaluation engine 100 and described with respect to FIG. 1. In addition, the evaluation engine 100 may be automated to process LUPs for multiple corresponding points of interest. In some embodiments, each LUP request may contain one LUP object and the evaluation may be against this one LUP object alone. In some embodiments, because LUP requests may be performed in parallel, any one individual LUP object may be accessed through the evaluation engine through a submitted request. The point of interest may be predetermined, selected by a user, or selected as a result of a process occurring outside of the evaluation engine 100 or hardware and software related to the evaluation engine 100.

In some embodiments, the identification parallel processing stage 220 may include identifying all points of interest 210a-210c for review and analysis. These points of interest 210a-210c may require authentication user server authentication 112 allowing for log event information 120 to be used to verify the identity and credentials of the users requesting LUPs for the points of interest 210a-210c. To this point, the identification parallel processing stage 220 may determine user information 212a-212c and location information 214a-214c to confirm credentials and access for any user requesting the LUP.

In some embodiments, the measurement parallel processing stage 270 may include evaluating information relating to the points of interest 210a-210c after credentials and access has been determined for each user in the identification parallel processing stage 220. The measurement parallel processing stage 270 may use geospatial mapping information 250 and historical location information 260 to calculate points, polylines, and/or polygons for each point of interest such that each point of interest may be coupled to corresponding databases 252, asset resources 254, parameters 256, and attribute data 258. These elements may provide information required for mapping and processing of the surroundings of the point of interest. The databases 252 may provide access to resources for each land use object (i.e., land already in use) in an area of interest. The asset resources 254 may be information relating to assets (i.e., pipelines, valves, or water lines) crossing the area of interest. The parameters 256 may be information on how the multiple assets and land use objects react to specific elements. For example, a parameter for a pipeline may include details relating to valves or tanks and how these elements may fit or interact with the pipeline. The attribute data 258 may include information relating to the parameters with respect to each asset in the area of interest. In some embodiments, the historical information 260 may include mapping history 262 indicative of previous land uses of the point of interest.

In some embodiments, the mapping parallel processing stage 280 may include using the data and information processed at the measurement parallel processing stage 270 to determine and correlate conflicts from the point of interest to the assets and land use objects in the area of interest. The conflicts may be based on organization data 283 that limits the changes between the information obtained from the geospatial mapping information 250. As such, the organization data 283 may include conflict tests 285 to determine the effect of the changes before releasing a LUP request determination.

In some embodiments, a request for LUP is divided into one or more obtaining periods (i.e., collection period 230) and/or one or more assessment periods (i.e., validation period 290). In the obtaining periods, data is collected by the various processing means with respect to each point of interest and this data is aggregated for processing. In the assessment periods, aggregated data is processed to determine object conflict parameters to include in the LUP.

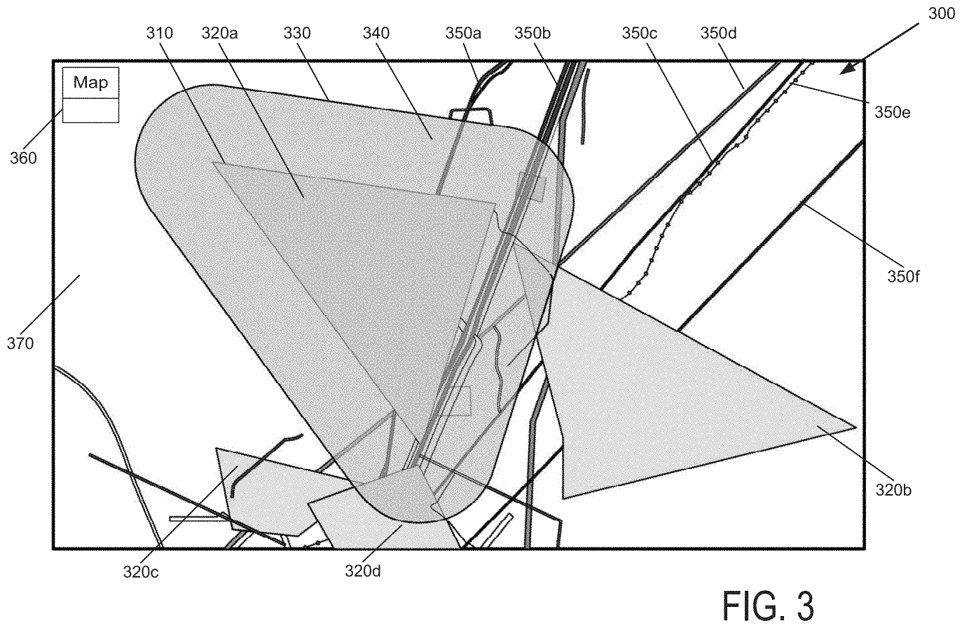

FIG. 3 shows an example of an output 300 of the evaluation engine 100 as an interactive conflict report mapped in an area of interest. The output 300 is an interactive version of the conflict report 170 in which a user may observe LUP details in a map. The output 300 in FIG. 3 may include a point of interest 310. The point of interest 310 is shown as polygon 320a, which is a land use object like land polygons 320b-320d in that these are land use objects or sub-areas of an area of interest 370. The point of interest 310 is shown as including a geographical buffer boundary 330 and a geographical buffer 340 that provides a space from the polygon 320a to the geographical buffer boundary 330. In this case, all elements of the buffer and the boundary may be analyzed as part of the conflict report and the processing stages described with respect to FIGS. 1 and 2. In addition, the conflict report may highlight elements in the area of interest 370 such that these elements are identified as assets identifiable by color. For example, assets 350a-350f may be colored differently to contrast their relation with respect to one another or based on a configuration parameter established in the evaluation engine 100. Further, a display selection 360 may be used to identify a type of map overlay to display for the area of interest 370, which may transition into a satellite overlay or a hybrid overlay. Any of the overlays may be used and these overlays may be configured prior to starting the conflict report 170.

In FIG. 3, the list of items displayed in the conflict report may be those that are identified by the evaluation engine 100 as either intersected or a distance away from the point of interest being reviewed. Further, tags may be assigned to each asset for easier identification. These tags may correspond to a specific color or may be unique in the area of interest being observed. Some tags may be directed towards a given point of interest 310 or elements relating the point of interest 310 such as the corresponding polygon 320a, the geographical buffer boundary, or the geographical buffer. For example, a map may include tags showing “approved width conditional points,” “rejected polygons”, “rejected lines,” or “approved polygons,” among others. In some embodiments, these tags may be related to individual LUP objects and may describe a LUP object status of the LUP request decision. In this regard, the evaluation engine may perform conflict analysis such that “rejected” LUPs (or any specific tagged object) may be excluded from any conflict analysis processes. In some embodiments, the elements highlighted in the map may be directed towards three main items. These items may be points, lines, and polygons. In the actual LUP determination, these items and many others may be provided with relevant labels like “Pipeline (lines),” “Wells (points),” and “Facilities (polygon).”

In some embodiments, the evaluation engine 100 may be a GIS based application (i.e., a LUP Explorer) used to create a LUP GIS object to be integrated with the evaluation engine 100. The LUP GIS object may be drawn or submitted for acceptance in a submission file (i.e., an Excel file). The file may be accepted as long as coordinates are defined to polygons, lines, points, or load shape files. The LUP Explorer may be a GIS application that has many functions and may consume the LAE to determine any conflict(s) with the submitted LUP. This may be done before the validation and review processes to minimize LUP rejections and optimize overall processing time.

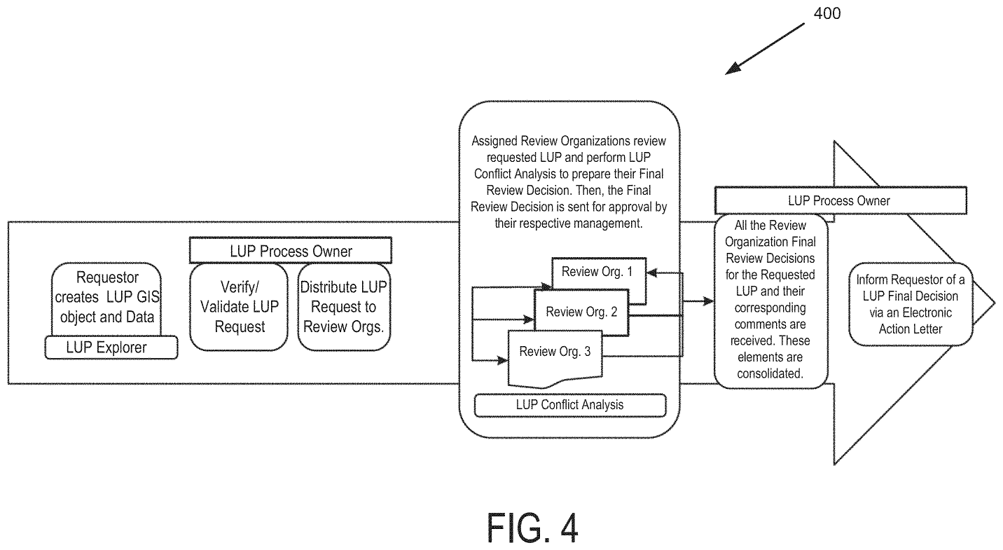

FIG. 4 shows an example of implementing a LUP process in accordance to one or more embodiments. The evaluation engine 100 may include LUP conflict analysis as described with respect to FIG. 2 and the evaluation may highlight and list assets and land use objects in relation to a point of interest based on whether these elements either partially intersect, completely intersect, or are disposed at a specific distance away from the point of interest being reviewed. In FIG. 4, a request for LUP and a LUP request determination are made by a LUP process owner. The LUP request determination is based on reviews from multiple organizations provided to the LUP process owner. As such, the LUP request determination is made based on feedbacks provided by the multiple organizations. Some LUPs may be approved with conditions. The conditions may be conflicts that need to be solved for the LUP to take effect. For the LUP process cycle, there may be three main user categories including Requestor, Reviewers, and LUP Processor. The complete LUP process lifecycle may start when a requestor initiates an LUP request. Then the LUP Processor may validate the request and if no observation is found, the request for the LUP may be sent to the Requestor to obtain the Requestor's management approval. The LUP Processor may receive an official (i.e., approved) LUP request, and based on a type and geographical location of the point of interest selected, a list of proposed and editable Review Organizations (ROs) may be generated automatically by the system. the LUP processor may assign the LUP request to any concerned organizations to review the LUP request and provide the organizations' decisions about the LUP request. Once all Review Organizations (ROs) complete the LUP review, the ROs select an applicable LUP determination to be “Approved,” “Approved with Conditions,” or “Rejected.” After that, the LUP Processor may consolidate all ROs' decisions and generate a digital action letter or conflict report that states a final decision of the requested LUP and forwards it to the LUP requestor. Because the process cycle of the LUP usually takes between 30 to 45 working days, the processes followed by the evolution engine reduce the process cycle to a few days based on the automated, intelligent, and tracked analysis.

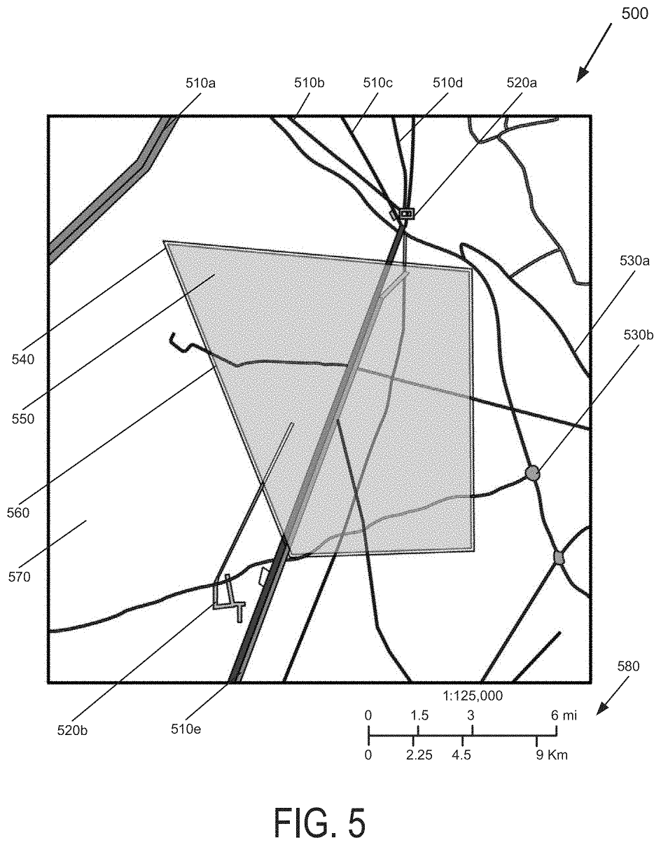

FIG. 5 illustrates an example of a map 500 in a LUP determination. The map 500 may include identified assets 510a-510e in a Land Use Permit determination for an area of interest 570. These assets 510a-510e may be any assets required for analysis based on a configuration of the conflict report. The map 500 may be generated automatically upon selecting a point of interest. In the map 500, the polygon 550 is representative of the point of interest in this example. The polygon 550 may include a geographical buffer 560 and a geographical buffer boundary 540 which may perform as those corresponding to the output 300 in FIG. 3. The map 500 may include additional tags highlighting conflicts. These conflict polygons 520a and 520b may be areas relating to a specific asset or land use object that creates a conflict result. The map 500 may include land use objects not considered assets, such as roads 530a and 530b. in addition, the LUP determination may calculate a scale 580 adjacent to the map 500. In this regard, like found objects affected by disaster areas, planning for flood analysis, identify areas affected by hydrocarbon releases, highlight areas coverage for rescue activities. Can be extended to many similar functions, like found objects affected by disaster areas, planning for flood analysis, identify areas affected by hydrocarbon releases, highlight areas coverage for rescue activities.

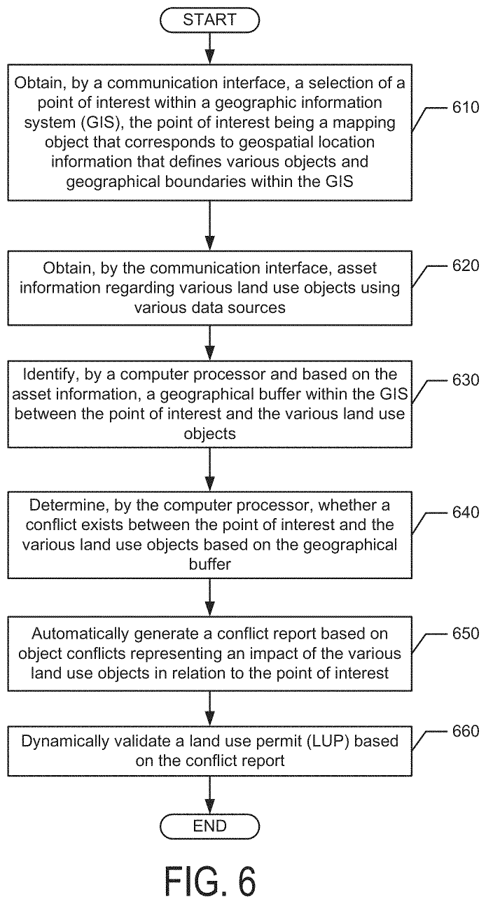

FIG. 6 shows a flowchart in accordance with one or more embodiments. Specifically, FIG. 6 describes a method for performing advanced configurable geospatial location analysis using the evaluation engine 100 described in reference to FIGS. 1-5. One or more blocks in FIG. 6 may be performed by one or more components as described in FIGS. 7A and 7B (e.g., computing system 700 including computer processor 704 and communication interface 708). While the various blocks in FIG. 6 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In some embodiments, one or more blocks in FIG. 6 may be implemented in an ArcGIS Server Platform as a Geospatial location analysis engine (i.e., an evaluation engine 100). The evaluation engine 100 may perform analysis linked to any location on Earth. The evaluation engine 100 may perform advanced analysis based on configurable selection of data to detect, illustrate, and list. The evaluation engine 100 may list and display all the assets and features described in reference to FIGS. 1-6, their types, and information based on some requested selection criteria. Any data evaluated by the evaluation engine 100 may be displayed and highlighted on a map based on a predetermined or selected display selection (e.g. display all facilities, or valves, or display all). Further, the data may be inserted into a report format using a word processing service (i.e., inserted and generated in Excel sheets and PDF files) including a map and list of the assets to use for further analysis or as a support document for decision making.

In Block 610, a communication interface obtains a selection of a point of interest within a geographic information system (GIS), the point of interest is a mapping object that corresponds to geospatial location information that defines various objects and geographical boundaries within the GIS. The communication interface receives a selection of one or more points of interest located in a same or different areas of interests. These points of interest are geospatial locations including their respective location information and historical data and applications. The evaluation engine 100 may be a web application that is not limited to a single user who may have a desktop application installed on a single machine.

In Block 620, the communication interface asset information regarding a plurality of land use objects using a plurality of data sources. The evaluation engine 100 does not require manual setting of any of the objects for conflict analysis.

In Block 630, a computer processor determines based on the asset information, a geographical buffer within the GIS between the point of interest and the plurality of land use objects. The evaluation engine 100 may identify objects that may be active or inactive to improve spatial analysis while consistently displaying attribute data. Only one buffer is generated which is based on the input parameter and it is created for the requested point of interest.

In Block 640, the computer processor determines whether an object conflict exists between the point of interest and the plurality of land use objects based on the geographical buffer. That is, the evaluation engine 100 may calculate the measured distances or determines which land use objects may be intersected with the point of interest. This process may be automated and saved in real-time to a customized report file such as PDF or Excel format documents.

In Block 650, a conflict report is automatically generated in a graphical user interface provided by the GIS, based on a plurality of LUP objects conflict parameters, the plurality of LUP objects conflict parameters representing an impact of the plurality of land use objects in relation to the point of interest. The evaluation engine 100 may be customizable to do the analysis against list of land use objects and assets which may be filtered by past parameters. Further, the evaluation engine 100 does not rely on a single interactively selected location on map by the user, not like this developed engine which performs geospatial analysis based on an object or objects fetched from a database by an object ID and performs geospatial analysis against configurable list of assets and objects based on passed variable parameters per every user role.

In Block 660, a LUP for an area of interest is dynamically validated based on the conflict report and the plurality of LUP objects conflict parameters. The evaluation engine 100 may be used to validate the LUP location and identify conflicts with other LUP projects by location. The evaluation engine 100 may perform conflict analysis using spatial overlay operations (i.e., buffer or intersections) between the requested LUP geometry, geometries for those ROs' LUPs having initiated, approved, approved with conditions, and pending LUPs statues, and features from any GIS reference layers the user is being granted access to. These results may be visualized as shown in FIG. 3.

Embodiments of the invention may be implemented on virtually any type of computing system, regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 7A, the computing system 700 may include one or more computer processor(s) 704, non-persistent storage 702 (e.g., random access memory (RAM), cache memory, flash memory, etc.), one or more persistent storage 706 (e.g., a hard disk, an optical drive such as a compact disk (CD) drive or digital versatile disk (DVD) drive, a flash memory stick, etc.), and numerous other elements and functionalities. The computer processor(s) 704 may be an integrated circuit for processing instructions. For example, the computer processor(s) 704 may be one or more cores, or micro-cores of a processor. The computing system 700 may also include one or more input device(s) 720, such as a touchscreen, keyboard, mouse, microphone, touchpad, electronic pen, or any other type of input device. Further, the computing system 700 may include one or more output device(s) 710, such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system 700 may be connected to a network system 730 (e.g., a local area network (LAN), a wide area network (WAN) such as the Internet, mobile network, or any other type of network) via a network interface connection (not shown). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system 700 may be located at a remote location and be connected to the other elements over a network system 730. Further, one or more embodiments of the invention may be implemented on a distributed system having various nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

The computing system 700 in FIG. 7A may be connected to or be a part of a network. For example, as shown in FIG. 7B, the network system 730 may include multiple nodes (e.g., node 732a to node 734n). Each node may correspond to a computing system, such as the computing system shown in FIG. 7A, or a group of nodes combined may correspond to the computing system shown in FIG. 7A. By way of an example, embodiments of the disclosure may be implemented on a node of a distributed system that is connected to other nodes. By way of another example, embodiments of the disclosure may be implemented on a distributed computing system having multiple nodes, where each portion of the disclosure may be located on a different node within the distributed computing system. Further, one or more elements of the aforementioned computing system 700 may be located at a remote location and connected to the other elements over a network. As such, the aforementioned computing system 700 may be connected through a remote connection established using a 5G connection, such as a protocols established in Release 15 and subsequent releases of the 3GPP/New Radio (NR) standards.

Although not shown in FIG. 7B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node 732a to node 734n) in the network system 730 may be configured to provide services for a client device 740. For example, the nodes may be part of a cloud computing system, such as a communication network. The nodes may include functionality to receive requests from the client device 740 and transmit responses to the client device 740. The client device 740 may be a computing system, such as the computing system shown in FIG. 7A. Further, the client device 740 may include and/or perform all or a portion of one or more embodiments of the disclosure.

The computing system or group of computing systems described in FIGS. 7A and 7B may include functionality to perform a variety of operations disclosed herein. For example, the computing system(s) may perform communication between processes on the same or different systems. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until the server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, one authorized process may mount the shareable segment, other than the initializing process, at any given time.

Other techniques may be used to share data, such as the various data described in the present application, between processes without departing from the scope of the disclosure. The processes may be part of the same or different application and may execute on the same or different computing system.

Rather than or in addition to sharing data between processes, the computing system performing one or more embodiments of the disclosure may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol Secure (HTTPs) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the disclosure, may extract one or more data items from the obtained data. For example, the extraction may be performed as follows by the computing system 700 in FIG. 7A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail—such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 7A, while performing one or more embodiments of the disclosure, may perform data comparison. Data comparison may be used to compare two or more data values (e.g., A, B). For example, one or more embodiments may determine whether A>B, A=B, A!=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the disclosure, A and B may be vectors, and comparing A with B includes comparing the first element of vector A with the first element of vector B, the second element of vector A with the second element of vector B, etc. In one or more embodiments, if A and B are strings, the binary values of the strings may be compared.

The computing system in FIG. 7A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 7A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 7A and the nodes and/or client device in FIG. 7B. Other functions may be performed using one or more embodiments of the disclosure.

While FIGS. 1-7B show various configurations of components, other configurations may be used without departing from the scope of the disclosure. For example, various components in FIGS. 7A and 7B may be combined to create a single component. As another example, the functionality performed by a single component may be performed by two or more components.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A method for performing advanced configurable geospatial location analysis, the method comprising:
obtaining, by a communication interface, a selection of a point of interest within a geographic information system (GIS),
wherein the point of interest is a mapping object that corresponds to geospatial location information that defines a plurality of objects and geographical boundaries within the GIS;
obtaining, by the communication interface, asset information regarding a plurality of land use objects using a plurality of data sources;
identifying, by a computer processor and based on the asset information, a geographical buffer within the GIS between the point of interest and the plurality of land use objects; and
determining, by the computer processor, whether an object conflict exists between the point of interest and the plurality of land use objects based on the geographical buffer.

2. The method of claim 1, further comprising:
automatically generating a conflict report in a graphical user interface provided by the GIS, based on a plurality of object conflict parameters, the plurality of object conflict parameters representing an impact of the plurality of land use objects in relation to the point of interest.

3. The method of claim 2, further comprising:
dynamically validating a Land Use Permit (LUP) for an area of interest in which the point of interest selected is located, based on the conflict report and the plurality of object conflict parameters.

4. The method of claim 3, further comprising:
determining that the object conflict exists among the geographical buffer; and
rejecting the LUP for the area of interest until the object conflict is removed.

5. The method of claim 3, further comprising:
determining that the object conflict does not exists among the geographical buffer; and
approving the LUP for the area of interest.

6. The method of claim 3, wherein the geographical buffer is automatically identified based on a plurality of range types associated with the point of interest.

7. The method of claim 3, wherein the selection of the point of interest is performed automatically by a decision-making server.

8. The method of claim 3, wherein location information associated to the object conflict is extracted from the GIS and inserted into a decision-making report.

9. The method of claim 3, wherein the plurality of land use objects comprise drilling applications, production applications, and various areas identified as being affected by hydrocarbon releases.

10. A system for performing advanced configurable geospatial location analysis, the system comprising:
a communication interface that:
obtains a selection of a point of interest within a geographic information system (GIS),
wherein the point of interest is a mapping object that corresponds to geospatial location information that defines a plurality of objects and geographical boundaries within the GIS, and
obtains asset information regarding a plurality of land use objects using a plurality of data sources; and
a computer processor that:
identifies, based on the asset information, a geographical buffer within the GIS between the point of interest and the plurality of land use objects, and
determines whether an object conflict exists between the point of interest and the plurality of land use objects based on a geographical buffer.

11. The system of claim 10, wherein the computer processor further:
automatically generates a conflict report, in a graphical user interface provided by the GIS, based on a plurality of objects conflict parameters, the plurality of object conflict parameters representing an impact of the plurality of land use objects in relation to the point of interest.

12. The system of claim 11, wherein the computer processor further:
dynamically validates a Land Use Permit (LUP) for an area of interest, in which the point of interest selected is located, based on the conflict report and the plurality of object conflict parameters.

13. The system of claim 12, the system further comprising a decision-making server that:
determines that the object conflict exists among the geographical buffer, and
rejects the LUP for the area of interest until the polygon conflict is removed.

14. The system of claim 12, the system further comprising a decision-making server that:
determines that the object conflict does not exists among the geographical buffer, and
approves the LUP for the area of interest.

15. The system of claim 12, wherein the geographical buffer is automatically identified based on a plurality of range types associated to the point of interest.

16. The system of claim 12, wherein the selection of the point of interest is performed automatically by a decision-making server.

17. The system of claim 12, wherein location information associated to the object conflict is extracted from the GIS and inserted into a decision-making report.

18. The system of claim 12, wherein the plurality of land use objects comprise drilling applications, production applications, and various areas identified as being affected by hydrocarbon releases.

19. A non-transitory computer readable medium storing instructions executable by a computer processor, the instructions comprising functionality for:
obtaining a selection of a point of interest within a geographic information system (GIS),
wherein the point of interest is a mapping object that corresponds to geospatial location information that defines a plurality of objects and geographical boundaries within the GIS;
obtaining asset information regarding a plurality of land use objects using a plurality of data sources;
identifying, based on the asset information, a geographical buffer within the GIS between the point of interest and the plurality of land use objects; and
determining whether an object conflict exists between the point of interest and the plurality of land use objects based on the geographical buffer.

20. The non-transitory computer readable medium of claim 19, further comprising:
automatically generating a conflict report, based on a plurality of object conflict parameters, the plurality of objects conflict parameters representing an impact of the plurality of land use objects in relation to the point of interest.
